(19) United States
(12) Patent Application Publication
(10) Pub. No.: US 2014/0141119 A1
(43) Pub. Date: May 22, 2014

(54) PALATABILITY ENHANCING COMPOSITIONS

(71) Applicants: Manjuan Jenny She, Chesterfield, MO (US); Gary J. Woodward, University City, MO (US); Sandra Lyn, St. Louis, MO (US); Zulin Shi, Naperville, IL (US)

(72) Inventors: Manjuan Jenny She, Chesterfield, MO (US); Gary J. Woodward, University City, MO (US); Sandra Lyn, St. Louis, MO (US); Zulin Shi, Naperville, IL (US)

(73) Assignee: NESTEC SA, Vevey (CH)

(21) Appl. No.: 14/113,878

(22) PCT Filed: Apr. 19, 2012
(86) PCT No.: PCT/US12/34198

§ 371 Date: Jan. 3, 2014

Related U.S. Application Data
(60) Provisional application No. 61/518,081, filed on Apr. 29, 2011.

(51) Int. Cl. A23L 1/226

(52) U.S. Cl. CPC A23L 1/226
USPC 426/2; 426/534

(57) ABSTRACT

The invention provides palatability enhancing compositions comprising a palatability enhancing amount of two or more of tetrasodium pyrophosphate, one or more animal by-products, and one or more microbial proteins and comestible compositions comprising one or more comestible ingredients and the palatability enhancing compositions.

### CROSS REFERENCE TO RELATED APPLICATIONS

This application claims priority to U.S. Provisional Application Ser. No. 61/518,081 filed Apr. 29, 2011, the disclosure of which is incorporated herein by this reference.

### BACKGROUND OF THE INVENTION

1. Field of the Invention

The invention relates generally to palatability enhancing compositions and particularly to palatability enhancing compositions containing two or more palatability enhancing ingredients.

2. Description of Related Art

There are various ways of enhancing the palatability of comestible compositions. Addition of one or more ingredients that provide an appealing aroma or flavor can increase palatability. Ingredients that affect food qualities such as aroma, flavor, texture, or mouthfeel, can also affect palatability. It is known that, for some compositions, increasing sweetness or increasing fat or salt content can enhance palatability for some animals. Flavor enhancers, such as glutamic acid or its salts and various nucleotide or ribonucleotide compounds are known in the art to be palatability enhancers.

There are many known specific methods and compositions useful for enhancing palatability. For example, US20080085350A1 discloses a method for producing a palatability enhancer for a companion animal food product, wherein the method includes combining at least one aroma chemical selected from 2-methylfuran, 2-methylpyrrole, 2-methyl-thiophene and dimethyl disulfide with an animal or vegetarian digest composition. US20050276881A1 discloses a catnip palatability enhancer comprising nepetalactone in form of catnip, catnip oil, matatabi, extract of matatabi, nepetalactone, and/or active analog of nepetalactone.

Tetrasodium pyrophosphate (Na₄P₂O₇) is a common food additive. Tetrasodium pyrophosphate is found in foods such as tuna and chicken nuggets and in food analogs such as imitation crab meat. Tetrasodium pyrophosphate is also a palatability enhancer used in various foods such as pet foods. U.S. Pat. No. 6,254,920, U.S. Pat. No. 6,350,485, U.S. Pat. No. 7,244,460 and U.S. Pat. No. 7,186,437 disclose the use of tetrasodium pyrophosphate as a palatability enhancer or component thereof. Tetrasodium pyrophosphate is available commercially; methods for producing tetrasodium pyrophosphate are known to skilled artisans, e.g., U.S. Pat. No. 4,873,068, U.S. Pat. No. 4,873,068, and U.S. Pat. No. 4,997,634.

Even though there are many known methods and compositions useful for enhancing palatability, there is always a need for new methods and compositions that make foods and other comestible compositions more palatable.

### SUMMARY OF THE INVENTION

It is, therefore, an object of the invention to provide palatability enhancing compositions.

It is another object of the invention to provide comestible compositions having enhanced palatability.

It is a further object of the invention to provide methods for hydrating animals.

One or more of these or other objects are achieved using palatability enhancing compositions comprising a palatability enhancing amount of two or more of tetrasodium pyrophosphate, one or more animal by-products, and one or more microbial proteins. The palatability enhancing compositions are combined with one or more comestible ingredients to produce comestible compositions having enhanced palatability. In a preferred embodiment, water is combined with palatability enhancing amounts of tetrasodium pyrophosphate, one or more animal by-products, and one or more microbial proteins to produce a highly palatable water beverage that increases consumption and therefore hydration when offered to an animal.

Other and further objects, features, and advantages of the present invention will be readily apparent to those skilled in the art.

### DETAILED DESCRIPTION OF THE INVENTION

### Definitions

The term “animal” means any animal that may choose a comestible composition based upon its palatability, including human, avian, bovine, canine, equine, feline, hicrine, lupine, murine, ovine, or porcine animals.

The term “companion animal” means domesticated animals such as cats, dogs, rabbits, guinea pigs, ferrets, hamsters, mice, gerbils, horses, cows, goats, sheep, donkeys, pigs, and the like.

The term “animal by-product” means ground, rendered, and cleaned slaughtered meat carcass parts such as necks, feet, undeveloped eggs, bones, heads, feathers, and intestines and the products produced by processing such ingredients.

The term “animal digest” means material which results from chemical and/or enzymatic hydrolysis of clean, undecomposed animal tissue. In certain embodiments, “animal digest” as used herein, is fully consistent with the definition of animal digest promulgated by the Association Of American Feed Control Officials, Inc. (AAFCO). Animal digest is preferably derived from animal tissues, including cold-blooded marine animals, excluding hair, horns, teeth, hooves, and feathers. The skilled artisan will appreciate that while such tissues are not preferred, trace amounts might be found unavoidably even under good manufacturing practices. Also not included are visceral contents or foreign or fecal matter, although trace contaminant amounts are sometimes present. When an animal digest is dried, it may be referred to as “dried animal digest.” Animal digests in accordance herewith are suitable for use in food or feed compositions. Specifically included are (1) Digest of Beef (or Poultry, Pork, Lamb, Fish, etc): material from beef (poultry, pork, etc.) which results from chemical and/or enzymatic hydrolysis of clean and undecomposed tissue; (2) Digest of Beef (or Pork, Lamb, etc) By-Products: material from beef (poultry, pork, etc.) which results from chemical and/or enzymatic hydrolysis of clean and undecomposed tissue from non-rendered clean parts from cattle (pigs, lambs, fish, etc), other than meat, for example lungs, spleen, kidneys, brain, livers, blood, bone, partially-defatted low-temperature fatty tissue, and stomachs and intestines, freed of their contents; and (3) Digest of Poultry By-Products: material which results from chemical and/or enzymatic hydrolysis of clean and undecomposed tissue from non-rendered clean parts of carcasses of slaughtered poultry such as heads, feet, and viscera. As used herein “poultry” encompasses any species or kind of bird, preferably chicken, turkey, duck, or other food species.

The term “single package” means that the components of a kit are physically associated in or with one or more containers and considered a unit for manufacture, distribution, sale, or use. Containers include, but are not limited to, bags, boxes, cartons, bottles, packages of any type or design or material, over-wrap, shrink-wrap, affixed components (e.g., stapled, adhered, or the like), or combinations thereof. A single package may be containers of individual ingredients, (e.g., tetrasodium pyrophosphate, animal by-products, microbial proteins, and comestible ingredients such as water) physically associated such that they are considered a unit for manufacture, distribution, sale, or use.

The term “virtual package” means that the components of a kit are associated by directions on one or more physical or virtual kit components instructing the user how to obtain the other components, e.g., a bag or other container containing one component and directions instructing the user to go to a website, contact a recorded message or a fax-back service, view a visual message, or contact a caregiver or instructor to obtain instructions on how to use the kit or safety or technical information about one or more components of a kit.

As used herein, ranges are used herein in shorthand, so as to avoid having to list and describe each and every value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “an animal” or “a method” includes a plurality of such “animals” or “methods.” Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context.

The terms “comprising” or “including” are intended to include embodiments encompassed by the terms “consisting essentially of” and “consisting of”. Similarly, the term “consisting essentially of” is intended to include embodiments encompassed by the term “consisting of”.

All percentages expressed herein are by weight of the total weight of the composition unless expressed otherwise.

The methods and compositions and other advances disclosed here are not limited to particular methodology, protocols, and reagents described herein because, as the skilled artisan will appreciate, they may vary. Further, the terminology used herein is for the purpose of describing particular embodiments only, and is not intended to, and does not, limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

### The Invention

In one aspect, the invention provides palatability enhancing compositions. The palatability enhancing compositions comprise a palatability enhancing amount of two or more of tetrasodium pyrophosphate, one or more animal by-products, and one or more microbial proteins. In preferred embodiments, the palatability enhancing compositions comprise a palatability enhancing amount of tetrasodium pyrophosphate, one or more animal by-products, and one or more microbial proteins.

Generally, animal by-products useful in the composition include animal digest and rendered meals such as pork meal, beef meal, poultry meal, greaves meal, fish meal, and the like. In preferred embodiments, the animal by-product is animal digest.

Generally, microbial proteins useful in the composition include single cell protein sources such as spirulina and various yeasts. In preferred embodiments, the microbial protein is brewer's yeast.

Generally, the composition comprises any palatability enhancing amounts or combinations of two or more of tetrasodium pyrophosphate, animal by-products, and microbial proteins. Typically, the palatability enhancing compositions comprising two of tetrasodium pyrophosphate, animal by-products, and microbial proteins contain the materials in amounts of from about 10 to about 90% of one and 90 to about 10% of an other, preferably from about 20 to about 80% of one and from about 80 to about 20% of the other. More preferably about 50% of each. When tetrasodium pyrophosphate is used with one other of the palatability enhancing ingredients, the tetrasodium pyrophosphate comprises from about 10 to about 50% of the composition, preferably from about 10 to about 40%.

When the palatability enhancing compositions comprise tetrasodium pyrophosphate, animal by-products, and microbial proteins, the compositions typically comprises from about 5 to about 40% tetrasodium pyrophosphate, from about 20 to about 60% of one or more animal by-products, and from about 20 to about 60% of one or more microbial proteins. In other embodiments, the composition comprises from about 10 to about 30% tetrasodium pyrophosphate, from about 30 to about 50% of one or more animal by-products, and from about 30 to about 50% of one or more microbial proteins. In preferred embodiments, the tetrasodium pyrophosphate comprises from about 10 to about 30% of the composition. In certain embodiments, the composition comprises about 20% tetrasodium pyrophosphate, about 40% of one or more animal by-products, and about 40% of one or more microbial proteins. In others, about 25% tetrasodium pyrophosphate, about 45% of one or more animal by-products, and about 30% of one or more microbial proteins. In still others, about 10% tetrasodium pyrophosphate, about 60% of one or more animal by-products, and about 40% of one or more microbial proteins.

The invention is based upon the discovery that a combination of two or more tetrasodium pyrophosphate, animal by-products, and microbial proteins enhance the palatability of comestible compositions when the combination is integrated into, applied to, mixed into, or dissolved in the comestible compositions. These ingredients interact in various combinations to enhance palatability. In certain combinations, the ingredients interact synergistically to enhance palatability.

In another aspect, the invention provides comestible compositions having enhanced palatability. The comestible compositions comprise one or more comestible ingredients and a palatability enhancing composition comprising a palatability enhancing amount of two or more of tetrasodium pyrophosphate, one or more animal by-products, and one or more microbial proteins. In preferred embodiments, the palatability enhancing compositions comprise a palatability enhancing amount of tetrasodium pyrophosphate, one or more animal by-products, and one or more microbial proteins.

Generally, the comestible compositions include foods, beverages, treats, snacks, supplements, edible animal toys, condiments, and the like. In certain embodiments, the comestible compositions are food compositions. In preferred embodiments, the comestible compositions are beverages such as water, milk, or milk analogs. In certain embodiments, the beverages are mixtures of two or more comestible beverage ingredients, e.g., water and flavors or water and lime juice or water and milk. In various embodiments, the beverages are formulated for canines or felines, particularly cats. In a preferred embodiment, the beverages are hydration beverages such as waters intended for companion animals, particularly dogs and cat. In a preferred embodiment, the comestible composition is water. In others, the beverages are milk or milk analogs formulated for felines, particularly cats.

Generally, the comestible ingredients useful in the comestible compositions of the invention, including the comestible compositions useful in the methods described herein, include any comestible ingredient, e.g., ingredient to make comestible food compositions or beverages. In preferred embodiments, the comestible ingredient is water, preferably potable water. In other embodiments, the comestible ingredients are components of food compositions. In certain embodiments, the food compositions comprise a macronutrient composition suitable for the type of food being designed. In one embodiment, a food composition has about 20 to 32% protein, about 30 to 50% carbohydrate, about 5% to 20% fat, and about 5% to 25% moisture. In another embodiment, the food composition is a pet food composition such as a premium or super-premium pet food composition. In one embodiment, the pet food is formulated for canines and has a protein content of about 20 to 30%, preferably about 24 to 29%, and more preferably about 25 to 28%. In another embodiment, the food composition is formulated for felines and has a protein content of about 35 to 45%, preferably about 37 to 42%, and more preferably about 39 to 41%. In a preferred embodiment, the composition is a food composition comprising melatonin, carotenoids, and optional zinc, and further comprising about 15% to about 50% protein, about 5% to about 40% fat, about 5% to about 10% ash content, and having a moisture content of about 5% to about 20%. The protein can be derived from vegetable proteins such as soybean meal, soy protein concentrate, corn gluten meal, wheat gluten, cottonseed, and peanut meal, or animal proteins such as casein, albumin, and meat protein. Examples of meat protein useful herein include pork, lamb, equine, poultry, fish, beef, and mixtures thereof. Examples of carbohydrates include grains or cereals such as rice, corn, milo, sorghum, alfalfa, barley, soybeans, canola, oats, wheat, and mixtures thereof. Fats are typically animal fats such as tallow. The food compositions may also optionally comprise other materials such as dried whey and other dairy by-products. In some embodiments, the ash content of such food compositions ranges from less than 1% to about 15%, preferably from about 5% to about 10%.

In a preferred embodiment, the food composition is a complete and nutritionally balanced pet food. In this embodiment, the pet food may be a “wet food”, “dry food”, or “intermediate moisture food.” “Wet food” describes pet food that is typically sold in cans or foil bags, and has a moisture content typically in the range of about 70% to about 90%. “Dry food” describes pet food that is of a similar composition to wet food, but contains a limited moisture content, typically in the range of about 5% to about 15% or 20%. Dry food is usually in the form of biscuits or kibbles. Dry food products include a variety of foods of various moisture contents, such that they are relatively shelf-stable and resistant to microbial or fungal deterioration or contamination. Also preferred are dry food compositions that are extruded food products such as pet foods or snack foods for either humans or companion animals. “Intermediate moisture food” describes pet food that has a moisture content typically in the range of about 20% to about 50%.

The food compositions may also comprise one or more fiber sources. The term “fiber” includes all sources of “bulk” in the food whether digestible or indigestible, soluble or insoluble, fermentable or nonfermentable. Preferred fibers are from plant sources such as marine plants but microbial sources of fiber may also be used. A variety of soluble or insoluble fibers may be utilized, as will be known to those of ordinary skill in the art. The fiber source can be beet pulp (from sugar beet), gum arabic, gum talha, psyllium, rice bran, carob bean gum, citrus pulp, fructooligosaccharide, pectin, short chain oligofructose, mannanoligofructose, soy fiber, arabinogalactan, galactooligosaccharide, arabinoxylan, or mixtures thereof. Alternatively, the fiber source can be a fermentable fiber. Fermentable fiber has previously been described to provide a benefit to the immune system of a companion animal.

Preferably, the food compositions are formulated for a companion animal, e.g., a dog or cat. In a preferred embodiment, the food composition is a pet food, preferably a kibble.

Generally, animal by-products useful in the comestible compositions of the invention include animal digest and rendered meals such as pork meal, beef meal, poultry meal, greaves meal, fish meal, and the like. In preferred embodiments, the animal by-product is animal digest.

Generally, microbial proteins useful in the comestible compositions of the invention include various yeasts. In preferred embodiments, the microbial protein is brewer's yeast.

Typically, the palatability enhancing compositions comprising two of tetrasodium pyrophosphate, animal by-products, and microbial proteins contain the materials in amounts of from about 10 to about 90% of one and 90 to about 10% of the other, preferably from about 20 to about 80% of one and from about 80 to about 20% of the other. Generally, when tetrasodium pyrophosphate is used with one other material, the tetrasodium pyrophosphate comprises from about 10 to about 50% of the composition, preferably from about 10 to about 40%.

When the palatability enhancing compositions comprise tetrasodium pyrophosphate, animal by-products, and microbial proteins, the compositions typically comprises from about 5 to about 40% tetrasodium pyrophosphate, from about 20 to about 60% of one or more animal by-products, and from about 20 to about 60% of one or more microbial proteins. In other embodiments, the composition comprises from about 10 to about 30% tetrasodium pyrophosphate, from about 30 to about 50% of one or more animal by-products, and from about 30 to about 50% of one or more microbial proteins. In preferred embodiments, the tetrasodium pyrophosphate comprises from about 10 to about 30% of the composition. In certain embodiments, the composition comprises about 20% tetrasodium pyrophosphate, about 40% of one or more animal by-products, and about 40% of one or more microbial proteins; about 25% tetrasodium pyrophosphate, about 45% of one or more animal by-products, and about 30% of one or more microbial proteins; and about 10% tetrasodium pyrophosphate, about 60% of one or more animal by-products, and about 40% of one or more microbial proteins.

In certain preferred embodiments, the comestible ingredient comprises water and the palatability enhancing composition comprises from about 5 to about 40% tetrasodium pyrophosphate, from about 20 to about 60% of animal digest, and from about 20 to about 60% of brewer's yeast. Generally, the comestible composition comprises from about 90 to about 99.95% water and from about 0.05 to about 10% of the palatability enhancing composition.

Typically, the comestible composition comprises from about 90 to about 99.95% of one or more comestible ingredients and from about 0.05 to about 10% of the palatability enhancing composition.

In certain embodiments, the comestible ingredient in the comestible composition comprises water and the palatability enhancing composition comprises tetrasodium pyrophosphate, one or more animal by-products, and one or more microbial proteins. In others, the comestible ingredient in the comestible composition comprises water and the palatability enhancing composition comprises from about 5 to about 40% tetrasodium pyrophosphate, from about 20 to about 60% of animal digest, and from about 20 to about 60% of brewer's yeast. Generally, the comestible composition comprises from about 90 to about 99.95% water and from about 0.05 to about 10% of the palatability enhancing composition.

In another aspect, the invention provides methods for hydrating animals. The methods comprise administrating to the animals a comestible composition comprising beverage and a palatability enhancing composition comprising a palatability enhancing amount of two or more of tetrasodium pyrophosphate, one or more animal by-products, and one or more microbial proteins. Preferably the beverage is water or a water based beverage. The comestible composition has enhanced palatability compared to the beverage alone. The animal consumes more of the comestible composition in a given unit of time than the animal would have consumed of the beverage alone, thereby hydrating the animal.

In preferred embodiments, the beverage is water, milk, or a milk analog as described herein, most preferably water.

In various embodiments, the animal by-product is animal digest and the microbial protein is brewer's yeast.

Generally, the methods use comestible compositions that comprise from about 90 to about 99.95% beverage and from about 0.05 to about 10% of the palatability enhancing composition.

In preferred embodiments, the palatability enhancing composition comprises tetrasodium pyrophosphate, one or more animal by-products, and one or more microbial proteins. Typically, the palatability enhancing composition comprises from about 5 to about 40% tetrasodium pyrophosphate, from about 20 to about 60% of one or more animal by-products, and from about 20 to about 60% of one or more microbial proteins. In a preferred embodiment, the palatability enhancing composition comprises from about 5 to about 40% tetrasodium pyrophosphate, from about 20 to about 60% of animal digest, and from about 20 to about 60% of brewer's yeast. The preferred beverage is water.

The comestible compositions are administered using any suitable method, preferably orally. In preferred embodiments, the comestible compositions are a mixture of water and the palatability enhancing compositions for administration to the animal as a beverage, e.g., a flavored water drink.

Preferably, the methods are used to hydrate non-human animals such as canines and felines, preferably companion animals such as dogs and cats.

In a further aspect, the invention provides kits suitable for enhancing the palatability of comestible compositions. The kits comprise in separate containers in a single package or in separate containers in a virtual package, as appropriate for the kit component, at least one of tetrasodium pyrophosphate, animal by-products, and microbial proteins, e.g., tetrasodium pyrophosphate and one or more of (1) at least one of a different one of tetrasodium pyrophosphate, animal by-products, and microbial proteins, e.g., animal digest, brewer's yeast, or combination thereof; (2) one or more comestible ingredients, e.g., a beverage such as water; (3) one or more gastrointestinal tract improving agents selected from the group consisting of probiotics and prebiotics, (4) one or more bottles, bowls, or spoons, and (5) instructions for how to use the kit components to produce a comestible composition, particularly a comestible composition useful for hydrating animals.

When the kit comprises a virtual package, the kit is limited to instructions in a virtual environment in combination with one or more physical kit components. The kit contains tetrasodium pyrophosphate, animal by-products, or microbial proteins and other kit components in amounts sufficient to use the kits. Typically, tetrasodium pyrophosphate, animal by-products, and microbial proteins and the other suitable kit components (e.g., water or kibbles) are admixed just prior to consumption by an animal. The kits may contain the kit components in any of various combinations and/or mixtures. In one embodiment, the kit contains a packet containing two or more of tetrasodium pyrophosphate, animal by-products, and microbial proteins and a container of food for consumption by an animal. The kit may contain additional items such as a device for mixing palatability enhancing composition and ingredients or a device for containing the admixture, e.g., a water bottle or a food bowl.

In other embodiments, the kit contains one of tetrasodium pyrophosphate, animal by-products, and microbial proteins in one container and another of tetrasodium pyrophosphate, animal by-products, and microbial proteins in another container. In other embodiments, the kit two of tetrasodium pyrophosphate, animal by-products, and microbial proteins in one container and the other of tetrasodium pyrophosphate, animal by-products, and microbial proteins in a separate container. All combinations of such tetrasodium pyrophosphate, animal by-products, and microbial proteins are encompassed in the invention. The container can be any suitable container compatible with the kit components, e.g., bottles, sachets, and the like. In some embodiments, tetrasodium pyrophosphate, animal by-products, and microbial proteins in the kits are mixed with additional nutritional supplements such as vitamins and minerals that promote good health in an animal.

In one embodiment, the kit contains tetrasodium pyrophosphate, animal by-products, and microbial proteins in one container and a water in another container. In another, the kit comprises multipacks of tetrasodium pyrophosphate, animal by-products, and microbial proteins in containers and a beverage such as water in other containers.

The palatability enhancing compositions and comestible ingredients described herein are useful in the kits. Preferably, the comestible ingredient used in the kit is a food composition or water, e.g., kibbles or a container of water. In a preferred embodiment, the kit comprises a container such as a sachet containing palatability enhancing amounts of tetrasodium pyrophosphate, animal by-products, and microbial proteins, e.g., animal digest and brewer's yeast, and a container of a beverage such as milk, a milk analog, or water, preferably water.

In another aspect, the invention provides means for communicating information about or instructions for one or more of (1) using palatability enhancing compositions comprising a palatability enhancing amount of two or more of tetrasodium pyrophosphate, one or more animal by-products, and one or more microbial proteins for enhancing the palatability of comestible compositions; (2) admixing one or more comestible ingredients and two or more of tetrasodium pyrophosphate, one or more animal by-products, and one or more microbial proteins to produce comestible compositions having enhanced palatability, e.g., beverages, foods, dietary supplements, and the like suitable for consumption by animals; (3) using comestible compositions comprising one or more comestible ingredients and a palatability enhancing composition comprising a palatability enhancing amount of two or more of tetrasodium pyrophosphate, one or more animal by-products, and one or more microbial proteins for the benefit of animals, particularly for hydrating animals; and (4) using the kits of the present invention to produce comestible compositions having enhanced palatability. The means comprises one or more of a physical or electronic document, digital storage media, optical storage media, audio presentation, audiovisual display, or visual display containing the information or instructions. Preferably, the means is selected from the group consisting of a displayed website, a visual display kiosk, a brochure, a product label, a package insert, an advertisement, a handout, a public announcement, an audiotape, a videotape, a DVD, a CD-ROM, a computer readable chip, a computer readable card, a computer readable disk, a USB device, a FireWire device, a computer memory, and any combinations thereof.

In another aspect, the present invention provides packages useful for containing the palatability enhancing compositions of the invention. The packages comprise at least one material suitable for containing palatability enhancing compositions comprising a palatability enhancing amount of two or more of tetrasodium pyrophosphate, one or more animal by-products, and one or more microbial proteins and a label affixed to the material containing a word or words, picture, design, acronym, slogan, phrase, or other device, or combination thereof, that indicates that the package contains the palatability enhancing compositions. Typically, such device comprises the words “palatability enhancers” or “contents enhances the palatability of beverages” or an equivalent expression printed on the material. Any package configuration and packaging material suitable for containing the palatability enhancing compositions are useful in the invention, e.g., a bag, box, sachet, bottle, can, pouch, and the like manufactured from paper, plastic, foil, metal, and the like. In preferred embodiments, the package further comprises two or more of tetrasodium pyrophosphate, animal by-products, and microbial proteins. In various embodiments, the package further comprises at least one window that permit the package contents to be viewed without opening the package. In some embodiments, the window is a transparent portion of the packaging material. In others, the window is a missing portion of the packaging material.

### EXAMPLES

The invention can be further illustrated by the following examples, although it will be understood that these examples are included merely for purposes of illustration and are not intended to limit the scope of the invention unless otherwise specifically indicated.

### Example 1

Each of twelve (12) flavored water drinks (formulas B-M, Table 1) was made by dissolving additives in tap water at ambient temperature (22-28° C.) in the proportions shown in Table 1. Formulas B-M were designated as “test variable” and formula A which is tap water only was the “control.”

TABLE 1

| | Composition per 100 g Water | | | | | | |
|---|---|---|---|---|---|---|---|
| | | Animal | Micro- | | Vitamins | Dried | |
| For- | Wa- | Hydro- | bial | | & | Chicken | Natural |
| mula | ter | lysate | Protein | TSPP | Minerals | Stock | Flavor |
| A | 100 | — | — | — | — | — | — |
| B | 100 | 0.4 | — | — | — | — | — |
| C | 100 | — | 0.39 | — | — | — | — |
| D | 100 | — | — | 0.2 | — | — | — |
| E | 100 | — | — | — | 0.01 | — | — |
| F | 100 | 0.4 | — | — | 0.01 | — | — |
| G | 100 | — | 0.39 | — | 0.01 | — | — |
| H | 100 | — | — | 0.2 | 0.01 | — | — |
| I | 100 | 0.4 | — | 0.2 | 0.01 | — | — |
| J | 100 | 0.4 | 0.39 | 0.2 | — | — | — |
| K | 100 | 0.4 | 0.39 | 0.2 | 0.01 | — | — |
| L | 100 | 0.362 | 0.355 | 0.181 | 0.042 | 0.1 | — |
| M | 100 | 0.362 | 0.355 | 0.181 | 0.042 | — | 0.1 |

### Example 2

Equal amounts of test variable B and control A of Example 1 were offered to a cat in separate bowls at the same time in a paired comparison test. The duration of the offering was four (4) hours. This was repeated with a panel of 60 cats with randomization of the left and right side placement of the test and control bowls. Standard dry cat food was also provided for the duration of the test. The amount of test variable B consumed by each cat was recorded and the average consumption for the 60 cats calculated and shown in Table 2. Also the amount of control A consumed for each pairing was recorded and the average percent consumption of test variable B versus the control A was calculated and shown in Table 2. Feeding comparisons of test variables C-M of Example 1 were repeated as for test variable B and the results shown in Table 2.

TABLE 2

| | Average Water | Average Consumption |
|---|---|---|
| Formula | Consumption (g) | (%) versus Water |
| A | 23 | — |
| B | 37 | 74 |
| C | 30 | 68 |
| D | 36 | 78 |
| E | 33 | 50 |
| F | 44 | 57 |
| G | 32 | 60 |
| H | 59 | 75 |
| I | 78 | 83 |
| J | 73 | 90 |
| K | 74 | 90 |
| L | 62 | 89 |
| M | 60 | 89 |

### Example 3

For control A, a panel of 57 cats was offered only tap water for four (4) hours. Standard dry cat food was provided during tests as in Example 1. The amount of water consumed by each cat was recorded. Average water consumption (g) was calculated. This test was repeated six (6) times with the same panel and the average consumption calculated and shown in Table 2.

Referring to the Tables, water containing the additives, or combinations of the additives synergistically, increased water consumption versus water without the additives. All additives or combinations of additives except vitamins & minerals improved palatability of the water containing the additives compared to water without the additives.

In the specification, there have been disclosed typical preferred embodiments of the invention. Although specific terms are employed, they are used in a generic and descriptive sense only and not for purposes of limitation. The scope of the invention is set forth in the claims. Obviously many modifications and variations of the invention are possible in light of the above teachings. It is therefore to be understood that within the scope of the appended claims the invention may be practiced otherwise than as specifically described.

1. A palatability enhancing composition comprising a palatability enhancing amount of two or more of tetrasodium pyrophosphate, one or more animal by-products, and one or more microbial proteins.

2. The palatability enhancing composition of claim 1 wherein the animal by-product is animal digest.

3. The palatability enhancing composition of claim 1 wherein the microbial protein is brewer's yeast.

4. (canceled)

5. The palatability enhancing composition of claim 1 comprising tetrasodium pyrophosphate, one or more animal by-products, and one or more microbial proteins.

6. The palatability enhancing composition of claim 5 comprising from about 5 to about 40% tetrasodium pyrophosphate, from about 20 to about 60% of one or more animal by-products, and from about 20 to about 60% of one or more microbial proteins.

7. (canceled)

8. A comestible composition comprising one or more comestible ingredients and a palatability enhancing composition comprising a palatability enhancing amount of two or more of tetrasodium pyrophosphate, one or more animal by-products, and one or more microbial proteins.

9. (canceled)

10. (canceled)

11. The comestible composition of claim 8 wherein the comestible ingredient is water.

12. The comestible composition of claim 11 wherein the comestible composition is formulated for felines.

13. (canceled)

14. The comestible composition of claim 8 wherein the comestible ingredient is milk or a milk analog.

15. The comestible composition of claim 14 wherein the milk analog is a milk analog formulated for felines.

16. (canceled)

17. The comestible composition of claim 8 wherein the animal by-product is animal digest.

18. The comestible composition of claim 8 wherein the microbial protein is brewer's yeast.

19. (canceled)

20. The comestible composition of claim 8 wherein the palatability enhancing composition comprises tetrasodium pyrophosphate, one or more animal by-products, and one or more microbial proteins.

21. The comestible composition of claim 20 wherein the palatability enhancing composition comprises from about 5 to about 40% tetrasodium pyrophosphate, from about 20 to about 60% of one or more animal by-products, and from about 20 to about 60% of one or more microbial proteins.

22. (canceled)

23. The comestible composition of claim 8 comprising from about 90 to about 99.95% of one or more comestible ingredients and from about 0.05 to about 10% of the palatability enhancing composition.

24. (canceled)

25. The comestible composition of claim 8 wherein the comestible ingredient comprises water and the palatability enhancing composition comprises from about 5 to about 40% tetrasodium pyrophosphate, from about 20 to about 60% of animal digest, and from about 20 to about 60% of brewer's yeast.

26. (canceled)

27. A method for hydrating an animal comprising administrating to the animal a comestible composition comprising a beverage and a palatability enhancing composition comprising a palatability enhancing amount of two or more of tetrasodium pyrophosphate, one or more animal by-products, and one or more microbial proteins.

28. The method of claim 27 wherein the animal by-product is animal digest.

29. The method of claim 27 wherein the microbial protein is brewer's yeast.

30. (canceled)

31. (canceled)

32. The method of claim 27 wherein the palatability enhancing composition comprises from about 5 to about 40% tetrasodium pyrophosphate, from about 20 to about 60% of one or more animal by-products, and from about 20 to about 60% of one or more microbial proteins.

33. (canceled)

34. The method of claim 27 wherein the beverage is water.

35. (canceled)

36. (canceled)

37. (canceled)

38. The method of claim 27 wherein the animal is a companion animal.

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)
